(19) United States
(12) Patent Application Publication
(10) Pub. No.: US 2020/0341899 A1
(43) Pub. Date: Oct. 29, 2020

(54) SYSTEM AND METHOD FOR PREDICTION BASED CACHE MANAGEMENT

(71) Applicant: EMC IP Holding Company LLC, Hopkinton, MA (US)

(72) Inventors: Jonas Furtado Dias, Rio de Janeiro (BR); Rômulo Teixeira de Abreu Pinho, Niterói (BR); Adriana Bechara Prado, Niterói (BR); Vinicius Michel Gottin, Rio de Janeiro (BR); Tiago Salviano Calmon, Rio de Janeiro (BR); Owen Martin, Hopedale, MA (US)

(21) Appl. No.: 16/395,426

(22) Filed: Apr. 26, 2019

(51) Int. Cl. G06F 12/0862; G06N 20/00

(52) U.S. Cl. CPC G06F 12/0862; G06F 2212/1016; G06N 20/00

(57) ABSTRACT

A data processing device includes persistent storage, a cache for the persistent storage, and a cache manager. The persistent storage is divided into logical units. The cache manager obtains persistent storage use data; selects model parameters for a cache prediction model based on the persistent storage use data; trains the cache prediction model based on the persistent storage use data using the selected model parameters to obtain a trained cache prediction model; and manages the cache based on logical units of the persistent storage using the trained cache prediction model.

### BACKGROUND

Computing devices may generate data during their operation. For example, applications hosted by the computing devices may generate data used by the applications to perform their functions. Such data may be stored in persistent storage of the computing devices. Accessing data in persistent storage may be a slow process. For example, persistent storage may have access or read times that are orders of magnitude larger than access or read times of other components of a computing device such as memory.

### SUMMARY

In one aspect, a data processing device in accordance with one or more embodiments of the invention includes persistent storage, a cache for the persistent storage, and a cache manager. The persistent storage is divided into logical units. The cache manager obtains persistent storage use data; selects model parameters for a cache prediction model based on the persistent storage use data; trains the cache prediction model based on the persistent storage use data using the selected model parameters to obtain a trained cache prediction model; and manages the cache based on logical units of the persistent storage using the trained cache prediction model.

In one aspect, a method for operating a data processing device includes a persistent storage divided into logical units and a cache for the persistent storage in accordance with one or more embodiments of the invention includes obtaining persistent storage use data of the persistent storage; selecting model parameters for a cache prediction model based on the persistent storage use data; training the cache prediction model based on the persistent storage use data using the selected model parameters to obtain a trained cache prediction model; and managing the cache based on logical units of the persistent storage using the trained cache prediction model.

In one aspect, a non-transitory computer readable medium in accordance with one or more embodiments of the invention includes computer readable program code, which when executed by a computer processor enables the computer processor to perform a method for operating a data processing device that includes a persistent storage divided into logical units and a cache for the persistent storage. The method includes obtaining persistent storage use data of the persistent storage; selecting model parameters for a cache prediction model based on the persistent storage use data; training the cache prediction model based on the persistent storage use data using the selected model parameters to obtain a trained cache prediction model; and managing the cache based on logical units of the persistent storage using the trained cache prediction model.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a data processing device in accordance with one or more embodiments of the invention.

FIG. 2 shows a diagram of example cache parameters in accordance with one or more embodiments of the invention.

FIG. 3 shows a flowchart of a method of managing a cache in accordance with one or more embodiments of the invention.

FIG. 4.1 shows a flowchart of a method of selecting model parameters in accordance with one or more embodiments of the invention.

FIG. 4.2 shows a flowchart of a method of selecting a sub-window in accordance with one or more embodiments of the invention.

FIG. 4.3 shows a flowchart of a method of selecting a limited feature set in accordance with one or more embodiments of the invention.

FIG. 5 shows a flowchart of a method of training a cache prediction model in accordance with one or more embodiments of the invention.

FIG. 6 shows a flowchart of a method of storing data in a cache in accordance with one or more embodiments of the invention.

FIGS. 7.1-7.6 show a non-limiting example of a system in accordance with embodiments of the invention.

FIG. 8 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to systems, devices, and methods for providing data storage services. For example, a system and/or device in accordance with embodiments of the invention may include persistent storage for storing data and a cache for the persistent storage. The cache may be used to provide high speed access to stored data that the persistent storage is unable to provide due to the different architectures of the persistent storage and cache. However, the cache may not be able to provide high speed access for all data stored in the persistent storage. Accordingly, high speed access may only be provided to a portion of the data of the persistent storage using the cache.

Embodiments of the invention may provide a method for managing caching of data in the cache that reduces cache misses when compared to contemporary methods for managing the cache. The method may provide for the selection of a model and model parameters that are used to generate a cache prediction model. The cache prediction model may be used to dynamically modify the caching behavior of the cache to respond to changing access patterns of the persistent storage. By doing so, the cache miss rate may be reduced when compared to contemporary methods for managing the caching behavior of a cache.

In one or more embodiments of the invention, the cache prediction model takes into account the granular access patterns of the persistent storage. For example, the cache prediction model may take into account the access patterns of the persistent storage at a logical unit level. By doing so, the caching behavior of the cache may be tailored so that different quantities of data are cached in response to cache misses occurring for different logical units of the persistent storage. As will be discussed in greater detail below, such caching behavior may be well suited to address the workloads imposed on the persistent storage by applications that frequently confine their access patterns to a limited number of logical units. Consequently, the caching behavior of the cache may be matched to the access patterns of applications that utilize the persistent storage.

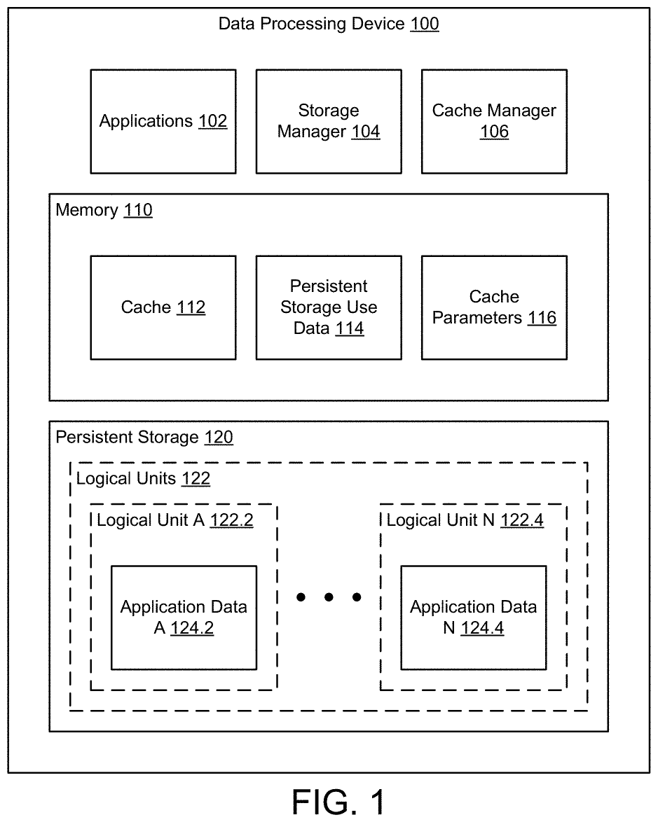

FIG. 1 shows a diagram of the data processing device (100) in accordance with one or more embodiments of the invention. The data processing device (100) may include computing resources (e.g., processing resources, memory resources, storage resources, communication resources, and/or other types). The data processing device (100) may be implemented as a physical or a logical device.

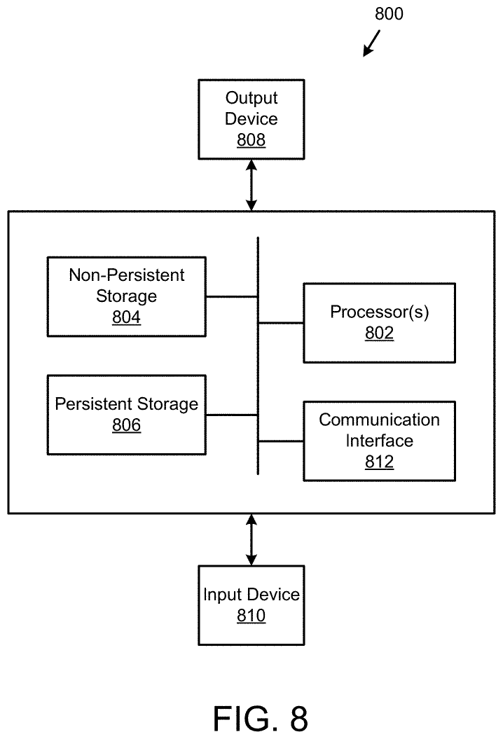

If implemented as a physical device, the computing resources may include processors, memory (e.g., 110), persistent storage (e.g., 120), etc. that provide the data processing device (100) with computing resources, If implemented as a logical device, the computing resources of the data processing device (100) may be the utilization, in whole or in part, of the physical computing resources of any number of computing devices by the data processing device (100). For additional information regarding computing devices, refer to FIG. 8.

For example, the data processing device (100) may be implemented as a virtual device that utilizes the virtualized resources, in whole or in part, of any number of computing devices. In another example, the data processing device (100) may be a distributed device. A distributed device may be a logical device that exists through the cooperative operation of any number of computing devices. The cooperative actions of the computing devices may give rise to the functionality of the data processing device (100). The data processing device (100) may be implemented as other types of physical or logical devices without departing from the invention.

In one or more embodiments of the invention, the data processing device (100) hosts one or more of the applications (102). The applications (102) may be logical entities that utilize the computing resources of the data processing device (100) for their execution. In other words, each of the applications (102) may be implemented as computer instructions stored in persistent storage (e.g., 120) that when executed by a processor of the data processing device (100) and/or other entities give rise to the functionality of the applications (102). The data processing device (100) may host any number of applications (102) without departing from the invention.

In one or more embodiments of the invention, all, or a part, of the functionality of the applications (102) is implemented as a specialized hardware device. The specialized hardware device may be, for example, a digital signal processor, a field programmable gate array, or an application specific integrated circuit. The functionality of the applications (102) may be provided via other types of hardware devices without departing from the invention.

The applications (102) may provide application services to users of the data processing device (100), other entities hosted by the data processing device (100), and/or to other entities that are remote, e.g., operably connected to the data processing device (100) via one or more wired and/or wireless networks, from the data processing device (100). For example, the applications (102) may be database applications, electronic communication applications, filesharing applications, and/or other types of applications.

Each of the applications (102) may perform similar or different functions. For example, a first application may be a database application and a second application may be an electronic communications application. In another example, a first application may be a first instance of a database application and a second application may be a second instance of the database application.

In one or more embodiments of the invention, all, or portion, of the applications (102) provide application services. The provided services may correspond to the type of application of each of the applications (102). When providing application services, the applications (102) may store application data (e.g., 124.2, 124.4). Stored application data may need to be accessed in the future.

To manage the storage and retrieval of data, the data processing device (100) may include a storage manager (104). The storage manager (104) may manager may provide data storage services to the applications (102) and/or other entities. Data storage services may include storage of data in persistent storage (120) and retrieval of data from the persistent storage (120).

However, the speed at which data stored in persistent storage (120) may be much slower than the speed at which data stored in memory (110) may be accessed. To improve the rate at which stored data may be accessed, the storage manager (104) may utilize a cache (112) for the persistent storage (120).

The cache (112) may be a data structure storing a portion of the data included in the persistent storage (120). When data is to be retrieved from the persistent storage (120), the storage manager (104) may first check to determine whether a copy of the data is stored in the cache (112). If there is a copy of the data stored in the cache (112), the storage manager (104) may retrieve the data from the cache (112) rather than from the persistent storage (120). By doing so, the time required for obtaining the data may be greatly reduced when compared to obtaining the data from the persistent storage (120).

If a copy of the data is not in the cache (112), e.g., the occurrence of a cache miss, the storage manager (104) may obtain the data from the persistent storage (120). When a cache miss occurs, the storage manager (104) may update the cache (112) by storing a copy of the data in the cache (112). Additionally, the storage manager (104) may store additional data that is stored in storage locations adjacent to the data in the persistent storage (120) in the cache (112). The storage manager (104) may store additional data based on cache parameters (116) for the cache.

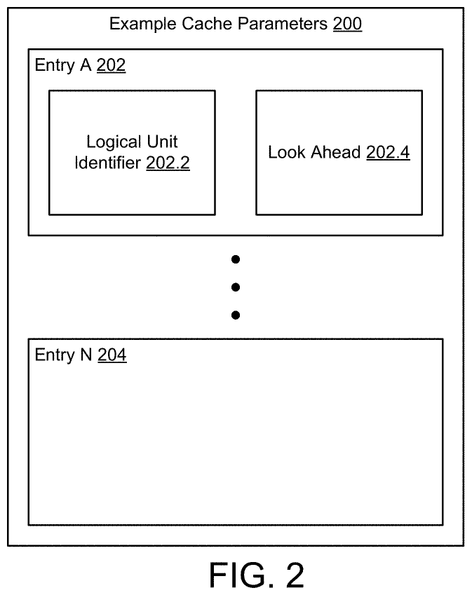

The cache parameters (116) may be a data structure that specifies that amount of additional information to be stored when a cache miss occurs. The cache parameters (116) may be maintained by the cache manager (106). For additional details regarding the cache parameters (116), refer to FIG. 2.

In one or more embodiments of the invention, the storage manager (104) is a hardware device including circuitry. The storage manager (104) may be, for example, a digital signal processor, a field programmable gate array, or an application specific integrated circuit. The storage manager (104) may be other types of hardware devices without departing from the invention.

In one or more embodiments of the invention, the storage manager (104) is implemented as computing code stored on a persistent storage that when executed by a processor performs the functionality of the storage manager (104). The processor may be a hardware processor including circuitry such as, for example, a central processing unit or a microcontroller. The processor may be other types of hardware devices for processing digital information without departing from the invention.

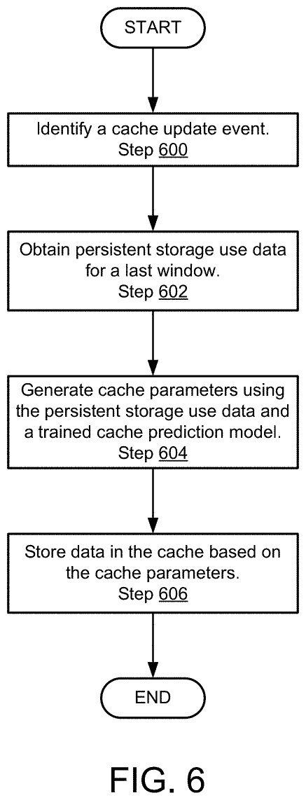

To provide the above noted functionality of the storage manager (104), the storage manager (104) may perform all, of a portion, of the methods illustrated in FIGS. 6.

As noted above, the cache manager (106) may manage the cache parameters (116) that impact the copies of data from the persistent storage (120) stored in the cache (112). To do so, the cache manager (106) may monitor the use of the persistent storage and store the results of the monitoring in memory (110) as persistent storage use data (114). For example, the persistent storage use data (114) may include information regarding when and what data was stored in the persistent storage. Such information may be used to deduce storage use patterns that are present on the data processing device (100). Because of the wide variety of applications (102) that each may have different use patterns, the use patterns of the persistent storage (120) of the data processing device (100) may be substantially different from the use patterns of persistent storage of other data processing devices. Consequently, a once-size fits all approach to store copies of data in the cache (112) may be inefficient due to the different use patterns of different data processing devices.

The cache manager (106) may, using the persistent storage use data (114), predict amounts of additional data that may be stored in the cache (112) that are likely to minimize cache misses. By doing so, the time required to access stored data may be reduced by making it more likely that the cache (112), rather than the persistent storage (120), will be used to access copies of previously stored data.

Additionally, the cache manager (106) may make such predictions and update the cache parameters (116) on a regular basis. By doing so, the cache parameters (116) may be consistently updated to make changing use patterns of the persistent storage (120).

Further, the cache manager (106) may generate cache parameters (116) that are granularized at a logical unit level. For example, the persistent storage (120) may be logically divided into different logical units (122). A logical unit may be a logical demarcation of storage resources of the persistent storage (120). The persistent storage (120) may include any number of logical units (e.g., 122.2, 122.4).

Different applications of the applications (102) may preferentially utilize the storage resources of different logical units of the persistent storage (120). Consequently, use patterns of the persistent storage (120) may be predominately divided along the demarcations of the logical units (122). The cache manager (106) may generate cache parameters (116) that include parameters for each of the logical units (122) of the persistent storage (120). Accordingly, when the storage manager (104) addresses a cache miss by storing a copy of data and some additional data in the cache (112), the amount of additional data may vary depending on which of the logical units (122) of the persistent storage (120) in which the data was stored. By providing cache parameters (116) that are granularized as a logical unit level, the cache manager (106) may further tailor the amount of additional data stored in the cache (112) to correspond with the patterns of accessing data in each of the logical units (122). Consequently, the likelihood of a cache miss occurring may be further reduced.

In one or more embodiments of the invention, the cache manager (106) is a hardware device including circuitry. The cache manager (106) may be, for example, a digital signal processor, a field programmable gate array, or an application specific integrated circuit. The cache manager (106) may be other types of hardware devices without departing from the invention.

In one or more embodiments of the invention, the cache manager (106) is implemented as computing code stored on a persistent storage that when executed by a processor performs the functionality of the cache manager (106). The processor may be a hardware processor including circuitry such as, for example, a central processing unit or a microcontroller. The processor may be other types of hardware devices for processing digital information without departing from the invention.

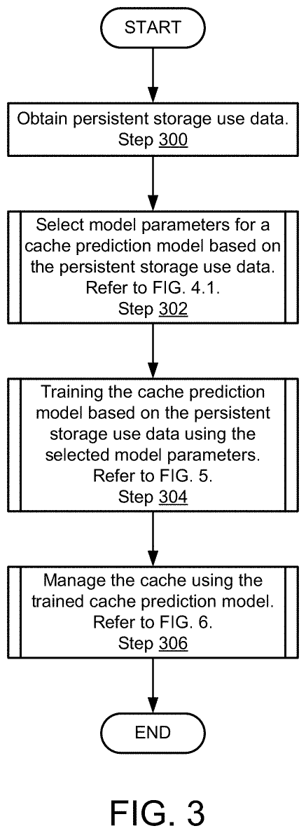

To provide the above noted functionality of the cache manager (106), the cache manager (106) may perform all, or a portion, of the methods illustrated in FIGS. 3-6.

While the data processing device (100) of FIG. 1 has been described and illustrated as including a limited number of components for the sake of brevity, a data processing device (100) in accordance with embodiments of the invention may include additional, fewer, and/or different components than those illustrated in FIG. 1 without departing from the invention.

As discussed above, the cache manager (106) may generate cache parameters (116). FIG. 2 shows a diagram of example cache parameters (200) in accordance with one or more embodiments of the invention.

In one or more embodiments of the invention, the example cache parameters (200) are a data structure that includes information regarding the amount of additional data to store when a cache miss occurs. For example, when a storage manager attempts to obtain data, the storage manager may first attempt to obtain the data from a cache that stores a portion of the data stored in persistent storage. If the requested data is not stored in the cache, the data manager may obtain the data from persistent storage. The aforementioned behavior may be referred to as a cache miss. When a cache miss occurs, the cache may be updated so that a cache miss will not occur in the future. To do so, the requested data may be stored in the cache. Additionally, because of the likelihood that additional data located adjacent to the requested data in persistent storage will be requested in the future, a copy of the additional data may also be stored in the cache. By doing so, a single read operation from persistent storage may be used to both provide data to a requesting entity and update the cache in a manner that is likely to also avoid future cache misses.

To determine the amount of additional data to store in the cache, the storage manager may refer to the example cache parameters (200). The example cache parameters (200) may include associations between logical units of the persistent storage and an amount of additional data. Thus, when a cache miss occurs, the storage manager may determine the amount of additional data to store in the cache by performing a lookup based on the logical unit in which the requested data is stored in persistent storage. By doing so, the storage manager may determine a corresponding amount of additional data to be stored along with the requested data in the cache for the persistent storage when a cache miss occurs.

In one or more embodiments of the invention, the example cache parameters (200) is a list of entries (e.g. 202, 204). Each of the entries may specify an association between a logical unit of the persistent storage and a look ahead value. For example, an entry A (202) may include a logical unit identifier (202.2) and a look ahead (202.4) value. The logical unit identifier (202.2) may be an identifier of a logical unit of the persistent storage. The look ahead (202.4) value may indicate the amount of additional data to be stored in the cache along with requested data when a cache miss for data stored in a logical unit of the persistent storage identified by a logical unit identifier (202.2) occurs. The other entries of the example cache parameters (200) may include similar information for other logical units of the persistent storage. Thus, a look ahead (202.4) value may be determined by searching the example cache parameters (200) using a logical unit identifier associated with requested data that is stored in the persistent storage.

While the example cache parameters (200) have been described as a list of entries, the example cache parameters (200) may be stored in a different structure that departing from the invention. Further, while the example cache parameters (200) have been described as including a limited amount of information, the example cache parameters (200) may include additional, different, and/or less information than that illustrated in FIG. 2 without departing from the invention.

Additionally, while the cache parameters have been illustrated and described as being stored in memory of a data processing device, the cache parameters may be stored in other locations without departing from the invention. For example, in some embodiments of the invention, the storage manager may be implemented as a hardware device that includes onboard storage for the example cache parameters (200). Thus, the example cache parameters (200) may be used to program the storage manager to provide its functionality.

As described above, the cache manager may maintain the cache parameters used by the storage manager to provide data storage services. FIGS. 3-6 illustrates methods that may be used to generate and/or maintain cache parameters, store data, and retrieve data in accordance with one or more embodiments of the invention.

FIG. 3 shows a flowchart of a method in accordance with one or more embodiments of the invention. The method depicted in FIG. 3 be used to manage a cache in accordance with one or more embodiments of the invention. The method shown in FIG. 3 may be performed by, for example, a cache manager (e.g., 106, FIG. 1). Other components of the system illustrated in FIG. 1 may perform all, or a portion, of the method of FIG. 3 without departing from the invention.

While FIG. 3 is illustrated as a series of steps, any of the steps may be omitted, performed in a different order, additional steps may be included, and/or any or all of the steps may be performed in a parallel and/or partially overlapping manner without departing from the invention.

In step 300, persistent storage use data is obtained.

In one or more embodiments of the invention, the persistent storage use data may be obtained by monitoring the use of persistent storage by applications and/or other entities. For example, the persistent storage use data may include which entity utilized the persistent storage, when the persistent storage was utilized, what operation was performed in the use of the persistent storage, which portion of the persistent storage with utilized, and how much of the persistent storage was utilized in any particular interaction. The persistent storage use data may include additional, less, and/or different types of information regarding the use of persistent storage without departing from the invention.

The persistent storage use data may correspond to the use of the persistent storage over any period of time. For example, the period of time may be, for example, 1 minute, five minutes, 15 minutes, 30 minutes, one hour, etc.

In step 302, model parameters for cache prediction model are selected based on the persistent storage use data.

In one or more embodiments of the invention, the cache prediction model establishes a relationship between persistent storage use data and cache parameters for use during future periods of time. For example, the cache prediction model may specify the cache parameters to be used during a future period of time and take, as input, persistent storage use data corresponding to one or more past periods of time. Thus, the cache prediction model may be used to generate new cache parameters to be used by the system of FIG. 1.

In one or more embodiments of the invention, the cache prediction model is generated by a machine learning algorithm. A machine learning algorithm may be a computational method of predicting future behavior based on past behavior. In this context, the machine learning algorithm may be employed to generate a prediction for future cache parameters that are likely to minimize the number of cache misses.

In one or more embodiments of the invention, the machine learning algorithm is the random forest algorithm. The random forest algorithm may sort a set of decision trees with different configurations which, combined, minimizes a functional relationship. The functional relationship may be the cache parameters that likely minimize the number of future cache misses based on past persistent storage use data. The machine learning algorithm may be other types of algorithms without departing from the invention.

In one or more embodiments of the invention, the model parameters specify portions of the machine learning algorithm. For example, the model parameters may specify the list of inputs that are used in the functional relationship of the cache prediction model and the portion of the persistent storage use data that are used when evaluating the functional relationship of the cache prediction model.

For example, the cache prediction model may take, as input, portions of the persistent storage use data. Based on this input, the cache prediction model may provide cache parameters to use during a future period of time. The model parameters may select the portions of the persistent storage use data that are used as input to the cache prediction model.

Selection of the portions of the persistent storage use data may be important for functionality of embodiments of the invention. For example, using too much persistent storage use data may be overly burdensome from a computational resource use standpoint. However, using too little of the persistent storage use data may make the predictions, i.e., the predicted cache parameters, generated by the cache prediction model inaccurate. Thus, embodiments of the invention may provide an improved method for selecting model parameters that improves the accuracy of the cache prediction model while minimizing the computational burden for generating cache parameters.

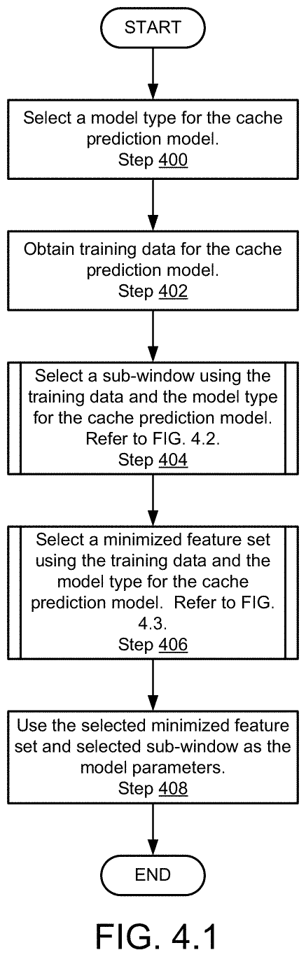

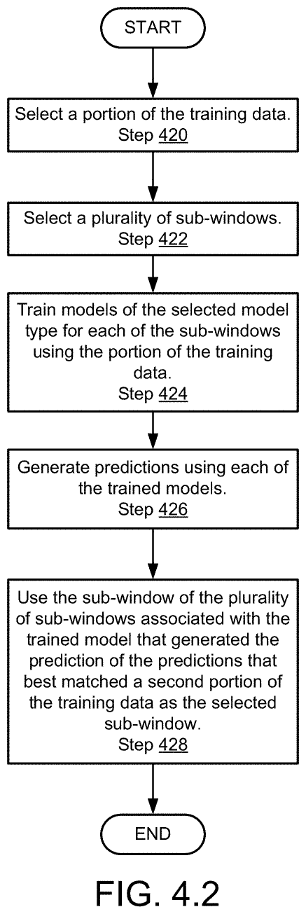

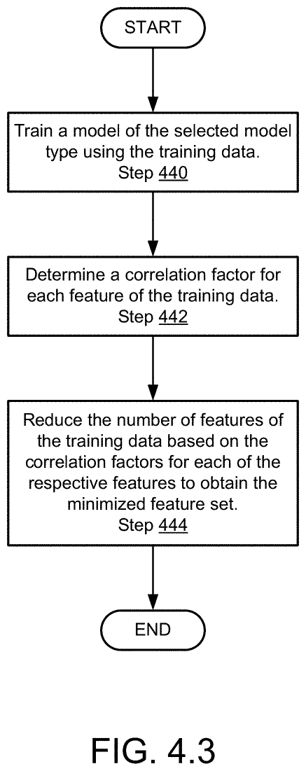

In one or more embodiments of the invention, the model parameters for the cache prediction model are selected using the method illustrated in FIG. 4.1. The model parameters for the cache prediction model may be selected via other methods without departing from the invention.

In step 304, the cache prediction model is trained based on the persistent storage use data using the selected model parameters.

In one or more embodiments of the invention, training the cache prediction model generates the functional relationship between persistent storage use data and cache parameters. In other words, training the cache prediction model places the functional relationship in a functional state. Thus, once trained, generating cache parameters may simply require using the functional relationship on additional persistent storage use data.

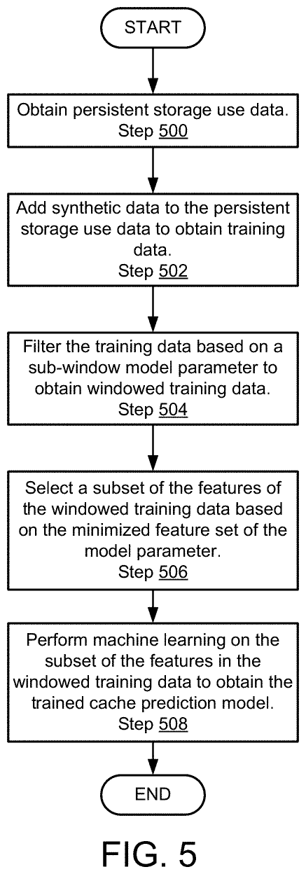

In one or more embodiments of the invention, the cache prediction model is trained via the method illustrated in FIG. 5. The cache prediction model may be trained via other methods without departing from the invention.

In step 306, the cache is managed using the trained cache prediction model.

In one or more embodiments of the invention, the cache is managed by periodically updating the cache parameters. Periodically updating the cache parameters may cause the behavior of the storage manager to periodically change. For example, the amounts of additional data to be stored in the cache may change dynamically over time. By doing so, the dynamically changing contents of the cache may be managed to match the changing uses of the persistent storage by applications and/or other entities.

In one or more embodiments of the invention, the cache is managed via the method illustrated in FIG. 6. The cache may be managed via other methods without departing from the invention.

The method may end following step 306.

FIG. 4.1 shows a flowchart of a method in accordance with one or more embodiments of the invention. The method depicted in FIG. 4.1 be used to select model parameters in accordance with one or more embodiments of the invention. The method shown in FIG. 4.1 may be performed by, for example, a cache manager (e.g., 106, FIG. 1). Other components of the system illustrated in FIG. 1 may perform all, or a portion, of the method of FIG. 4.1 without departing from the invention.

While FIG. 4.1 is illustrated as a series of steps, any of the steps may be omitted, performed in a different order, additional steps may be included, and/or any or all of the steps may be performed in a parallel and/or partially overlapping manner without departing from the invention.

In step 400, a model type for the cache prediction model is selected.

In one or more embodiments of the invention, the selected model type is a random forest model. The model type may be other types of machine learning models without departing from the invention. For example, the model type may be linear regression, the KNN (K-nearest neighbors) algorithm, support vector machines, or neural networks. Other model types may be used without departing from the invention.

In step 402, training data for the cache prediction model is obtained.

In one or more embodiments of the invention, the training data is persistent storage use data obtained from the data processing device. The persistent storage use data may be obtained during a typical workload period for the data processing device.

In one or more embodiments of the invention, the training data corresponds to data obtained from the data processing device over a predetermined period of time. For example, the predetermined period of time may be 15 minutes. Other predetermined periods of time may be used without departing from the invention.

In step 404, a sub-window is selected using the training data and the model type for the cache prediction model.

In one or more embodiments of the invention, the sub-window specifies a proportion of the data of the training data that will be used by the cache prediction model. In other words, it may be a time window which is used to filter the training data. Only the filtered training data may be used as input to the cache prediction model. The remaining data (filtered out) of the training data may be used for validation purposes. The sub-window may be used to filter persistent storage use data obtained in the future for future cache parameter prediction purposes.

In one or more embodiments, the sub-window is a window that begins at a point in time in the past and ends at the most recent point in time of training data. Thus, the sub-window may be used to filter out older data. However, the shorter the sub-window is, the less likely that accurate predictions will be generated by the cache prediction model.

To minimize the size of the sub-window while maintaining prediction accuracy, the sub-window may be selected via the method illustrated in FIG. 4.2. The sub-window may be selected via other methods without departing from the invention.

In step 406, a minimized feature set is selected using the training data and the model type for the cache prediction model.

In one or more embodiments of the invention, the minimized feature set specifies one or more features of the training data. The minimized feature set may be used to filter persistent storage use data obtained in the future for future cache parameter prediction purposes.

The persistent storage use data may be multi-dimension data that includes many features. The minimized feature set may be used to reduce the number of features in the persistent storage use data. By doing so, the computational cost for generating predictions using the cache prediction model may be reduced. However, reducing the number of features included in the persistent storage use data may reduce the accuracy of the cache prediction mode.

To minimize the number of features in the minimized feature set while maintaining prediction accuracy, the minimized feature set may be selected via the method illustrated in FIG. 4.3. The minimized feature set may be selected via other methods without departing from the invention.

For example, correlation factors for each of the features may be identified. The correlation factors may express the correlation between the features and the output of a model. In this example, the correlation factors may correlate respective features, e.g., cache parameters, with the output of the model. The correlation factors may be used to determine which features may be excluded while limiting deviation of the output of models that use a limited number of the features from the output of the model that utilizes all of the features. By doing so, a model that utilizes a subset of the features may be selected.

In step 408, the selected minimized feature set and the selected sub-window are used as the model parameters. The aforementioned model parameters may be selected by storing them for future use so that when the cache prediction model is used to generate a prediction, the cache prediction model utilizes only features specified by the selected minimized feature set and limits the features to data consistent with the time period specified by the selected sub-window.

The method may end following step 408.

FIG. 4.2 shows a flowchart of a method in accordance with one or more embodiments of the invention. The method depicted in FIG. 4.2 be used to select a sub-window in accordance with one or more embodiments of the invention. The method shown in FIG. 4.2 may be performed by, for example, a cache manager (e.g., 106, FIG. 1). Other components of the system illustrated in FIG. 1 may perform all, or a portion, of the method of FIG. 4.2 without departing from the invention.

While FIG. 4.2 is illustrated as a series of steps, any of the steps may be omitted, performed in a different order, additional steps may be included, and/or any or all of the steps may be performed in a parallel and/or partially overlapping manner without departing from the invention.

In step 420, a portion of the training data selected. As discussed above, the training data may be persistent storage use data. The persistent storage use data may correspond to a period of time. The portion of the training data may be selected so that a second portion of the training data may be used for validation purposes.

For example, consider a scenario where the training data corresponds to persistent storage use data corresponding to a period of 30 minutes. In such a scenario, the portion of the training data may be selected as the portion of the persistent storage use data that corresponds to the first 15 minutes of the 30 minute period. By doing so, the training data associated with the first 15 minutes may be used for training purposes, as discussed below, and the remaining 15 minutes may be used to judge the accuracy of the results of trained models.

In step 424, a plurality of sub-windows is selected. As discussed above, a sub-window may correspond to a period of time.

In one or more embodiments of the invention, the sub-windows are selected by dividing the period of time into a plurality of windows. The plurality of windows may serve as different samples used to train a model, as discussed in greater detail below. A sub-window of the plurality of sub-windows may correspond to a portion of each of the plurality of windows. Different sub-windows of the plurality of sub-windows may correspond to different portions of each of the plurality of windows. Sub-windows of different sizes, i.e., different portion sizes of each of the plurality of windows, may be selected to determine which sub-window size both provides accurate model results while reducing the total quantity of data used by models to generate predictions.

In one or more embodiments of the invention, the sub-windows are selected based on the plurality of windows of the selected portion of the training data. For example, resuming the discussion of the scenario with respect to step 420, after the portion of the training data is selected as the first 15 minutes of the training data, the 15 minutes of training data may be divided into 3 5 minute windows. Sub-windows may be selected as fraction percentages of the size of each of the plurality of windows. Thus, the sub-windows may correspond to the last 2.5 minutes, 1 minute, 0.5 minutes, and 0.25 minute of each of the plurality of windows.

In one or more embodiments of the invention, the plurality of sub-windows is selected as the last 50% of the size of each of the plurality of windows, the last 40% of the size of each of the plurality of windows, the last 30% of the size of each of the plurality of windows, the last 20% of the size of each of the plurality of windows, and the size of each of the plurality of windows. The plurality of sub-windows may correspond to different ratios of the size of each of the plurality of windows without departing from the invention.

In step 424, models of the selected model type are trained for each of the sub-windows using the portion of the training data.

In one or more embodiments of the invention, each of the models are trained by performing machine learning in accordance with the model types of the selected models and pre-conditioning the portion of the training data in accordance with the sub-window corresponding to each of the respective models. By doing so, cache prediction models may be generated for each of the plurality of sub-windows.

In Step 426, predictions are generated using each of the trained models.

In one or more embodiments of the invention, the predictions are the cache parameters. Thus, a plurality of different cache parameters may be generated that correspond to the plurality of sub-windows.

In step 428, the sub-window of the plurality of sub-windows that is associated with the trained model that generated the prediction of the predictions that best matched a second portion of the training data as the selected sub-window. In other words, the predictions generated in Step 426 may be compared to the remaining data of the training data to identify the prediction that had the best cache parameters that would have minimized the number of cache misses had the cache been used to service the data storage requests specified by the remaining data of the training data. The trained model that generated the best prediction did so using one of the sub-windows of the plurality of sub-windows. That sub-window, associated with the best prediction, is selected as the sub-window to use when generating future predictions by the cache prediction model.

The method may end following step 428.

FIG. 4.3 shows a flowchart of a method in accordance with one or more embodiments of the invention. The method depicted in FIG. 4.3 may be used to obtain a minimized feature set in accordance with one or more embodiments of the invention. The method shown in FIG. 4.3 may be performed by, for example, a cache manager (e.g., 106, FIG. 1). Other components of the system illustrated in FIG. 1 may perform all, or a portion, of the method of FIG. 4.3 without departing from the invention.

While FIG. 4.3 is illustrated as a series of steps, any of the steps may be omitted, performed in a different order, additional steps may be included, and/or any or all of the steps may be performed in a parallel and/or partially overlapping manner without departing from the invention.

In step 440, a model of the selected model type is trained using the training data.

The model may be trained similar to any of the models trained in steps 420 and 424 of FIG. 4.2. The selected sub-window of Step 428 may be used during the training. Different sub-windows may be used during the training without departing from the invention.

In Step 442, a correlation factor for each feature of the training data is determined.

In one or more embodiments of the invention, the correlation factor is a relative ranking of the importance of each of the features of the training data to the predictions generated by the trained model. For example, the trained model may be exercised, across each of its dimension, to determine how significant a change in each of the features in the training data makes to predictions generated by the trained model. Changes to features that result in larger changes to the predictions generated by the trained model are treated as larger correlation factors. The magnitude in the change in the prediction, attributed to each of the features, may be used as the correlation factor for each of the relative rankings.

For example, if the model is being generated using a random forest algorithm, the correlation factor may be the Gini index of each feature of the training data. In another example, if a regression model is being used, linear coefficients of the variables in the regression model may be used as the correlation factor for each feature. Other characteristics of the model may be used as the correlation factor without departing from the invention.

In step 444, the number of features of the training data are reduced based on the correlation factors for each of the respective features to obtain the minimized feature set.

In one or more embodiments of the invention, the number of features of the training data are reduced by eliminating any features that do not have a correlation factor that indicates that the future contributes to at least a predetermined percentage of the prediction generated by the trained model. The predetermined percentage may be, for example, 1%. Other predetermined percentages may be used without departing from the invention.

In one or more embodiments of the invention, the number of features of the training data are reduced using a statistical characterization of the correlation factors. For example, an elbow analysis of the correlation factors may be used to reduce the number of features of the training data by removing features of the training data that do not significantly contribute to the predictions. Other types of statistical characterizations, other than elbow analysis, may be used to reduce the features of the training data without departing from the invention.

The method may end following step 444.

By implementing the methods illustrated in FIGS. 4.1-4.4, model parameters may be obtained. The model parameters may be subsequently used in the method illustrated in FIG. 5.

FIG. 5 shows a flowchart of a method in accordance with one or more embodiments of the invention. The method depicted in FIG. 5 may be used to obtain a trained cache prediction model in accordance with one or more embodiments of the invention. The method shown in FIG. 5 may be performed by, for example, a cache manager (e.g., 106, FIG. 1). Other components of the system illustrated in FIG. 1 may perform all, or a portion, of the method of FIG. 5 without departing from the invention.

While FIG. 5 is illustrated as a series of steps, any of the steps may be omitted, performed in a different order, additional steps may be included, and/or any or all of the steps may be performed in a parallel and/or partially overlapping manner without departing from the invention.

In step 500, persistent storage use data is obtained. The persistent storage use data obtained in step 500 may be the same, or different data, from that obtained in the methods in FIGS. 4.1-4.3.

In one or more embodiments of the invention, the persistent storage use data is obtained from the data processing device while the applications hosted by the data processing device for utilizing persistent storage. In other words, live data of workloads that are likely to be present while the data processing device is operating during its normal use is obtained. The persistent storage use data may correspond to a period of 15 minutes. The persistent storage use data may correspond to different periods of time, e.g., 1 minute, 2, minutes, 5 minutes, 30 minutes, etc., without departing from the invention.

In step 502, synthetic data is added to the persistent storage use data to obtain training data.

In one or more embodiments of the invention, the synthetic data is statistical data regarding the persistent storage use data. The synthetic data may include, for example, the mean, statistics (e.g., variance, and percentiles over the period of time of the persistent storage use data) of the number of data access requests for each logical unit of the persistent storage, the size of the data access requests for each logical unit of the persistent storage, the number of each type of data access request for each logical unit of the persistent storage, the size of each type of operation for each logical unit of the persistent storage, the logical block addresses accessed for each logical unit of the persistent storage, the difference between the logical block addresses accessed in each subsequent operation for each logical unit of the persistent storage, and/or the sequentially (or randomness) of the access pattern across the logical block address space of each logical unit, for each type of unit, of the persistent storage. Each of these statistics may be derived from the persistent storage use data prior to adding the synthetic data, i.e., the aforementioned statistics. The resulting training data may be a table including the use data for the persistent storage and the statistics of the use data for the persistent storage. The training data may have a different structure without departing from the invention.

In step 504, the training data is filtered based on the sub-window model parameter to obtain windowed training data. In other words, the data included in the training data may be obtained over a period of time. The sub-window may specify a portion of the that period of time. Only the training data that was obtained during the portion of the period of time may be included in the windowed training data.

In step 506, a subset of the features of the windowed training data are selected based on the minimized feature set of the model parameters. In other words, only those features, e.g., one or more of the statistics, one or more of the original use data parameters such as a type of the data access, specified by the minimized feature set are selected.

In step 508, machine learning is performed on the subset of the features in the windowed training data to obtain the trained cache prediction model. By doing so, the trained cache prediction model may generate cache parameter predictions based only on a small amount of data, i.e., the features specified by the minimized feature set and only a the sub-portion of the training data. Accordingly, the resulting trained cache prediction model is able to generate such predictions using a far smaller amount of data than that collected to train the model.

The machine learning may be performed in accordance with the selected model type. For example, if the selected model type is the random forest algorithm, corresponding machine learning may be performed to generate a trained random forest model for predicting cache parameters.

The method may end following Step 508.

By implementing the method illustrated in FIG. 508, trained cache prediction models may be generated. The trained cache prediction models may be used in the method illustrate din FIG. 6.

FIG. 6 shows a flowchart of a method in accordance with one or more embodiments of the invention. The method depicted in FIG. 6 be used to manage a cache for a persistent storage in accordance with one or more embodiments of the invention. The method shown in FIG. 6 may be performed by, for example, a cache manager (e.g., 106, FIG. 1). Other components of the system illustrated in FIG. 1 may perform all, or a portion, of the method of FIG. 6 without departing from the invention.

While FIG. 6 is illustrated as a series of steps, any of the steps may be omitted, performed in a different order, additional steps may be included, and/or any or all of the steps may be performed in a parallel and/or partially overlapping manner without departing from the invention.

In step 600, a cache update event is identified.

In one or more embodiments of the invention, the cache update event is the occurrence of a predetermined point in time. For example, the cache may be periodically updated based on a schedule.

In one or more embodiments of the invention, the cache update event is the occurrence of a cache miss rate over a predetermined period of time. For example, the cache miss rate may be monitored and if it exceeds predetermined amount for the predetermined period of time a cache update event may be declared.

In step 602, persistent storage use data for a last window is obtained in response to the cache update event. As discussed above, the persistent storage use data may be continuously generated. Thus, the persistent storage use data for last window may be obtained by storing a portion of the continuously generated persistent storage use data.

In step 604, cache parameters are generated using the persistent storage use data and a trained cache prediction model.

In one or more embodiments of the invention, the cache parameters are generated by conditioning the persistent storage use data in accordance with model parameters used to train the trained cache prediction model. For example, statistics of the persistent storage use data may be added to the persistent storage use data. Additionally, features of the persistent storage use data may be removed to condition the persistent storage use data.

In one or more embodiments of the invention, the cache parameters are generated by using the persistent storage use data as input for the trained cache prediction model. In response, the trained cache prediction model may generate the cache parameters as output.

In one or more embodiments of the invention, the cache parameters are similar to those discussed with respect to FIG. 2. The cache parameters may include additional, different, and/or fewer parameters for operating a cache for persistent storage without departing from the invention.

In step 606, data is stored in the cache based on the cache parameters. For example, the storage manager may add data and additional data to the cache in accordance with the cache parameters. By doing so, the cache may be updated on a logical unit basis to better provide cache services.

The method may end following step 606.

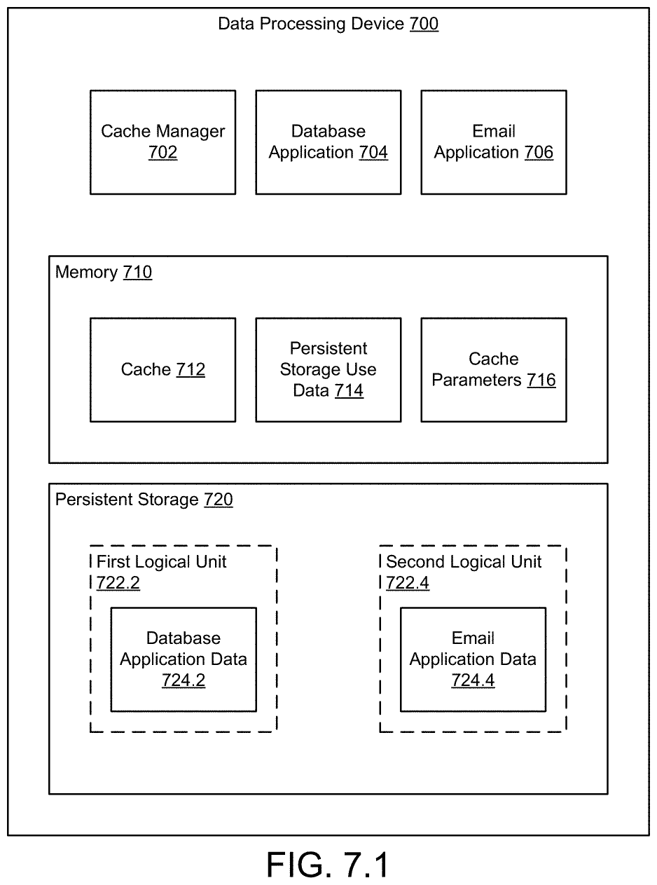

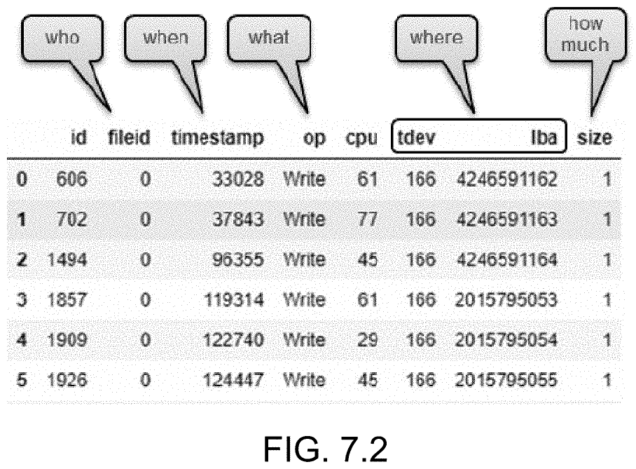

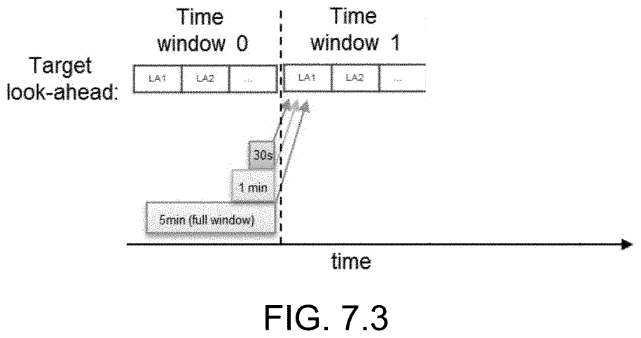

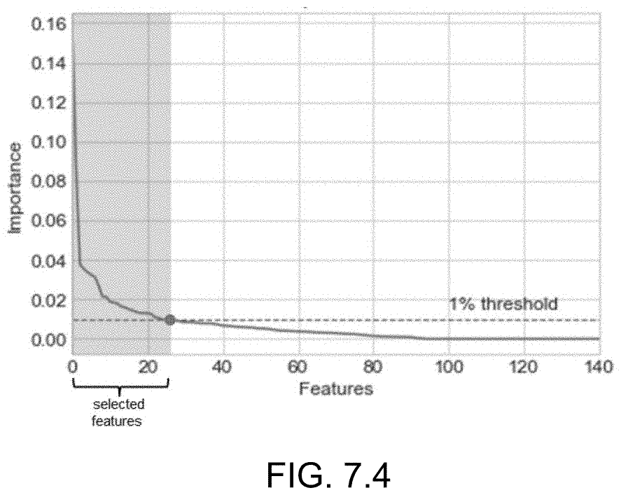

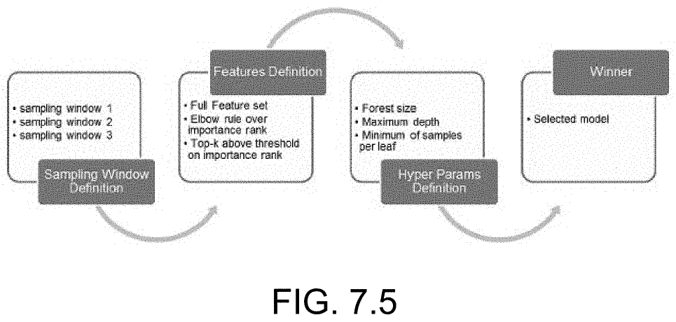

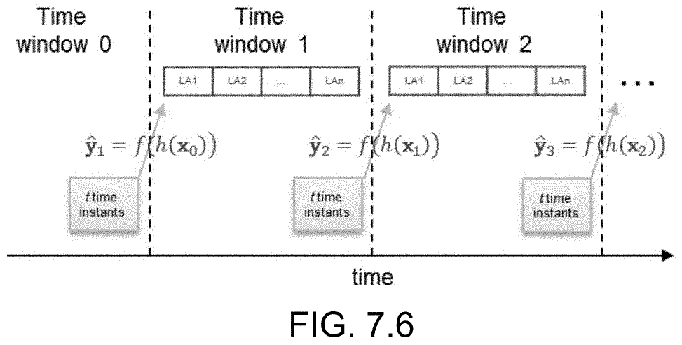

To further clarify embodiments of the invention, a non-limiting example is provided in FIGS. 7.1-7.6. Each of these figures may illustrate a system and/or data of the system similar to that illustrated in FIG. 1 at different points in times. For the sake of brevity, only a limited number of components of the system of FIG. 1 are illustrated in each of FIGS. 7.1-7.6.

### EXAMPLE

Consider a scenario as illustrated in FIG. 7.1 in which a data processing device (700) is providing application services to other devices operably connected to the data processing device (700). To provide application services, the data processing device (700) includes a database application (704) that provides database services and email application (706) that provides electronic communication services. When providing database services, the database application (704) stores database application data (724.2) in a first logical unit (722.2) a persistent storage (720) of the data processing device (700). Similarly, the email application (706) stores email application data (724.4) and a second logical unit (722.4) of the persistent storage (720).

While providing the aforementioned services, the database application (704) and the email application (706) periodically request access to the data stored in the persistent storage (720). To provide such access, a storage manager (not shown) manages access to the data by first attempting to access the cache (712) stored in memory (710) to determine if a copy of the data is stored in the cache (712). Because the data is not stored in the cache (712), the storage manager obtains the data from the persistent storage (720), provides the data to the aforementioned applications, and stores copy of the data in the cache (712). Additionally, different amounts of additional data are also stored in the cache (712) for different portions of the requested data based on cache parameters (716).

The cache parameters (716) were generated by a cache manager (702) based on persistent storage use data (714). The persistent storage use data (714) initially included information similar to that illustrated in FIG. 7.2. FIG. 7.2 shows a table of data obtained from monitoring access to the persistent storage. Each row in the table includes information regarding separate accesses of the persistent storage. Each column indicates different parameters of data access including an indicator of the entity that requested the access (fileid), when the access was performed (timestamp), the type of access (op), the logical block address that was accessed (lba), and the number of blocks that were accessed during each access (size).

To generate the cache parameters (716), the persistent storage use data (714) was enhanced by adding statistics (not shown) regarding the use data of the persistent storage. Adding the statistics to the persistent storage use data (714) resulted in the inclusion of 140 different features in the persistent storage use data (714).

Using the persistent storage use data (714), a sub-window was selected via the process illustrated in FIG. 7.3. FIG. 7.3 shows a diagram illustrating how different sub-windows impact the process for predicting cache parameters. For example, when persistent storage use data (714) is obtained over a given time window (e.g., 0, 1, 2), different sub-window sizes (e.g., 30 seconds, 1 minute, 5 minutes) may be used to truncate the amount of data included in the persistent storage use data (714) for prediction purposes. As the sub-window is decreased in size, smaller amounts of the persistent storage use data (714) are used to generate the cache parameters.

To determine a sub-window to use in the trained cache prediction model, three models were trained using sub-window durations of 5 minutes, 1 minute, and 30 seconds for persistent storage use data (714) associated with time windows 0 and 1 (a total duration of 10 minutes, 5 minutes each). Based on the resulting predictions, it was determined that a sub-window duration of 5 minutes and 1 minute generated predictions that closely matched the persistent storage use data during time window 1 while predictions generated using the 30 second sub-window duration did not closely match the persistent storage use data during time window 1. Consequently, a 1 minute sub-window was selected.

Once the sub-window was selected, a model was trained using the enhanced persistent storage data and exercised to determine the importance, i.e., correlation factor, of each of the features of the enhanced persistent storage use data as shown in FIG. 7.4. FIG. 7.4 shows a plot of the importance of each of the features of the enhanced persistent storage use data. As seen from FIG. 7.4, only 25 of the features contributed more than 1% to the predictions generated by the trained model. Consequently, the 25 features were selected as the minimized feature set.

After obtaining the sub-window and the minimized feature set, a model was trained via the machine learning processes shown in FIG. 7.5. As seen from FIG. 7.5, a Random Forest algorithm was used as the basis for the model. To train the model, the persistent storage use data (714) was divided into a number of windows and the model parameters, i.e., the sub-window and the limited feature set, were used to condition the windowed data to obtain input as a basis for training the model. The model was then trained resulting in the generation of a functional relationship, i.e., the trained cache prediction model, between persistent storage data conditioned based on the model parameters and cache parameters as output of the function.

Once the trained cache prediction model was generated, it was used by the cache manager (702) to generate the cache parameters (716) and periodically update the cache parameters (716) in response to the occurrence of future cache update events via the method illustrated in FIG. 7.6. As seen in FIG. 7.6, whenever a cache update event occurs as indicated by the vertical dashed lines, persistent storage use data is obtained corresponding to the time windows (e.g., 1, 2). The persistent storage use data (e.g., \hat{x}₀, \hat{x}₁, \hat{x}₂) is conditioned in accordance with the model parameters (e.g., h(xₙ) and used as input to the trained cache prediction model (e.g., f(h(xₙ)) to generate cache parameters (e.g., ŷ₁, ŷ₂, ŷ₃) for use until the next cache update event.

Thus, in the state of the system shown in FIG. 7.1, the system is capable of dynamically updating the behavior of the cache by causing different amounts of additional data to be added an a logical unit basis. Such updates may be performed in a computationally efficient manner using the trained cache prediction model.

### End of Example

As discussed above, embodiments of the invention may be implemented using computing devices. FIG. 8 shows a diagram of a computing device in accordance with one or more embodiments of the invention. The computing device (800) may include one or more computer processors (802), non-persistent storage (804) (e.g., volatile memory, such as random access memory (RAM), cache memory), persistent storage (806) (e.g., a hard disk, an optical drive such as a compact disk (CD) drive or digital versatile disk (DVD) drive, a flash memory, etc.), a communication interface (812) (e.g., Bluetooth interface, infrared interface, network interface, optical interface, etc.), input devices (810), output devices (808), and numerous other elements (not shown) and functionalities. Each of these components is described below.

In one embodiment of the invention, the computer processor(s) (802) may be an integrated circuit for processing instructions. For example, the computer processor(s) may be one or more cores or micro-cores of a processor. The computing device (800) may also include one or more input devices (810), such as a touchscreen, keyboard, mouse, microphone, touchpad, electronic pen, or any other type of input device. Further, the communication interface (812) may include an integrated circuit for connecting the computing device (800) to a network (not shown) (e.g., a local area network (LAN), a wide area network (WAN) such as the Internet, mobile network, or any other type of network) and/or to another device, such as another computing device.

In one embodiment of the invention, the computing device (800) may include one or more output devices (808), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (802), non-persistent storage (804), and persistent storage (806). Many different types of computing devices exist, and the aforementioned input and output device(s) may take other forms.

Embodiments of the invention may provide a cache for persistent storage that dynamically updates caching behavior on a logical unit basis. By doing so, the behavior of the cache may reflect changing access patterns of applications that utilize the persistent storage for data storage. Consequently, the cache may dynamically match its caching behavior to the changing access patterns of the applications. Doing so may reduce the likelihood of cache misses when compared to caches that do not (i) dynamically modify their caching behavior based on persistent storage use data or (ii) modify its caching behavior on a logical unit basis.

Thus, embodiments of the invention may address the problem of changing persistent storage access patterns. In modern distributed computing systems that periodically have dramatic changes in work loads (e.g., computing on demand services, cloud computing, etc.) resulting in changing persistent storage access patterns, caches that do not dynamically update their caching behavior are unable to respond to these changing workloads.

The problems discussed above should be understood as being examples of problems solved by embodiments of the invention disclosed herein and the invention should not be limited to solving the same/similar problems. The disclosed invention is broadly applicable to address a range of problems beyond those discussed herein.

One or more embodiments of the invention may be implemented using instructions executed by one or more processors of the data management device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A data processing device, comprising:
persistent storage divided into logical units;
cache for the persistent storage; and
a cache manager programmed to:
obtain persistent storage use data;
select model parameters for a cache prediction model based on the persistent storage use data;
train the cache prediction model based on the persistent storage use data using the selected model parameters to obtain a trained cache prediction model; and
manage the cache based on logical units of the persistent storage using the trained cache prediction model.

2. The data processing device of claim 1, wherein managing the cache, based on the logical units of the persistent storage, using the trained cache prediction model comprises:
in response to a cache update event:
generating new cache parameters for the cache using the trained cache prediction model; and
storing data in the cache based on the new cache parameters for a predetermined future period of time.

3. The data processing device of claim 2, wherein the cache parameters specify a look ahead quantity for each of the logical units, wherein the look ahead quantity is an amount of data that will be stored in the cache in addition to a portion of data obtained from the persistent storage when a cache miss occurs.

4. The data processing device of claim 2, wherein the cache parameters comprise a parameter for each of the logical units.

5. The data processing device of claim 2, wherein the new cache parameters for the cache are generated using the trained cache prediction model and are based, at least in part, second persistent storage use data associated with a first period of time that is different from a second period of time associated with the persistent storage use data.

6. The data processing device of claim 1, wherein training the cache prediction model based on the persistent storage use data using the selected model parameters to obtain a trained cache prediction model comprises:
obtaining second persistent storage use data;
adding synthetic data to the persistent storage use data to obtain training data;
filtering the training data based on a sub-window of the model parameters to obtain windowed training data;
select a subset of features of the windowed training data based on a minimized feature set of the model parameters; and
perform machine learning on the minimized feature set to obtain the trained cache prediction model.

7. The data processing device of claim 6, wherein performing machine learning on the minimized feature set comprises generating a functional relationship between the second persistent storage use data and cache parameters for the cache, wherein the cache parameters specify a quantity of data stored in the persistent storage to be stored in the cache when a cache miss occurs.

8. The data processing device of claim 1, wherein the cache is managed by periodically updating a quantity of data that is stored in the cache on a logical units of the persistent storage basis when a cache miss occurs.

9. A method for operating a data processing device comprising a persistent storage divided into logical units and a cache for the persistent storage, comprising:
obtaining persistent storage use data of the persistent storage;
selecting model parameters for a cache prediction model based on the persistent storage use data;
training the cache prediction model based on the persistent storage use data using the selected model parameters to obtain a trained cache prediction model; and
managing the cache based on logical units of the persistent storage using the trained cache prediction model.

10. The method of claim 9, wherein managing the cache, based on the logical units of the persistent storage, using the trained cache prediction model comprises:
in response to a cache update event:
generating new cache parameters for the cache using the trained cache prediction model; and
storing data in the cache based on the new cache parameters for a predetermined future period of time.

11. The method of claim 10, wherein the cache parameters specify a look ahead quantity for each of the logical units, wherein the look ahead quantity is an amount of data that will be stored in the cache in addition to a portion of data obtained from the persistent storage when a cache miss occurs.

12. The method of claim 10, wherein the cache parameters comprise a parameter for each of the logical units.

13. The method of claim 10, wherein the new cache parameters for the cache are generated using the trained cache prediction model and are based, at least in part, second persistent storage use data associated with a first period of time that is different from a second period of time associated with the persistent storage use data.

14. The method of claim 9, wherein training the cache prediction model based on the persistent storage use data using the selected model parameters to obtain a trained cache prediction model comprises:
obtaining second persistent storage use data;
adding synthetic data to the persistent storage use data to obtain training data;
filtering the training data based on a sub-window of the model parameters to obtain windowed training data;
select a subset of features of the windowed training data based on a minimized feature set of the model parameters; and
perform machine learning on the minimized feature set to obtain the trained cache prediction model.

15. The method of claim 14, wherein performing machine learning on the minimized feature set comprises generating a functional relationship between the second persistent storage use data and cache parameters for the cache, wherein the cache parameters specify a quantity of data stored in the persistent storage to be stored in the cache when a cache miss occurs.

16. The method of claim 9, wherein the cache is managed by periodically updating a quantity of data that is stored in the cache on a logical units of the persistent storage basis when a cache miss occurs.

17. A non-transitory computer readable medium comprising computer readable program code, which when executed by a computer processor enables the computer processor to perform a method for operating a data processing device comprising a persistent storage divided into logical units and a cache for the persistent storage, the method comprising:
obtaining persistent storage use data of the persistent storage;
selecting model parameters for a cache prediction model based on the persistent storage use data;
training the cache prediction model based on the persistent storage use data using the selected model parameters to obtain a trained cache prediction model; and
managing the cache based on logical units of the persistent storage using the trained cache prediction model.

18. The non-transitory computer readable medium of claim 17, wherein managing the cache, based on the logical units of the persistent storage, using the trained cache prediction model comprises:
in response to a cache update event:
generating new cache parameters for the cache using the trained cache prediction model; and
storing data in the cache based on the new cache parameters for a predetermined future period of time.

19. The non-transitory computer readable medium of claim 18, wherein the cache parameters specify a look ahead quantity for each of the logical units, wherein the look ahead quantity is an amount of data that will be stored in the cache in addition to a portion of data obtained from the persistent storage when a cache miss occurs.

20. The non-transitory computer readable medium of claim 17, wherein the cache is managed by periodically updating a quantity of data that is stored in the cache on a logical unit of the persistent storage basis when a cache miss occurs.
